(19) United States
(12) Patent Application Publication
(10) Pub. No.: US 2015/0302489 A1
(43) Pub. Date: Oct. 22, 2015

(54) COMPUTER IMPLEMENTED METHOD OF FACILITATING CHARITABLE DONATIONS

(71) Applicant: Mark B. Newbauer, Fort Wayne, IN (US)

(72) Inventor: Mark B. Newbauer, Fort Wayne, IN (US)

(21) Appl. No.: 14/258,054

(22) Filed: Apr. 22, 2014

(51) Int. Cl. G06Q 30/02; G06Q 20/10

(52) U.S. Cl. CPC G06Q 30/0279; G06Q 20/10

(57) ABSTRACT

A computer implemented method of facilitating a financial donation to a charitable organization, where the monetary donation is based on a percentage of a financial transaction and the steps of the method are performed by one or more programmed computer processors.

### BACKGROUND

1. Field of the Art

The present invention relates generally to a system and method of performing electronic financial transactions and, more particularly, to a system and method for automatically donating funds to charitable organizations as a consequence of such financial transactions.

2. Description of the Prior Art

Scrip is a fundraising tool for non-profit organizations like schools, churches, athletic groups, bands, community organizations and more. Organizations earn money by having people use gift cards to pay for everyday purchases. Non-profit organization members buy gift cards at full face value and use them in place of cash, checks, or credit cards for everyday shopping. The organization buys the gift cards at a reduced cost. The difference in price is contributed to the organization.

Scrip is also issued in the form of gift certificates or gift cards. The two are essentially the same except that the cards automate the checkout and accounting processes. Cards usually have a barcode or magnetic strip, which can be processed through a standard electronic credit card machine.

Gifts cards are increasingly being offered as consumer incentives at no cost or for a substantial discount. For example, reward points given for the use of credit cards can be exchanged for a variety of gift cards and some companies will offer high value gift cards at a discount. Gift cards are readily available at a discount using online trading services.

There are websites where users can trade, donate, buy and sell gift cards. Sellers use these websites because the gift card is not to a store of their liking, and buyers because this provides opportunities to buy these cards for less than they are nominally worth at the business. There are other websites that sell a collection of third party gift cards; businesses offer credits to these websites for employee incentives, usually in return for a discount.

The current scrip system, however, has a number of drawbacks. The current system for distribution of, and accounting for, traditional scrip is time-consuming and arduous, as the paper certificates are transferred from the participating stores to the distributors, the organizations, and finally to the consumers. Typically the distributor pays the participating merchants on a weekly or monthly basis for scrip. Scrip is sent from each merchant to the distributor, who must manually sort and file the various types of scrip. With the receipt of orders from the numerous organizations, the various merchants' scrip is accumulated for each order and then sent back to the ordering organization. Thus, the current system is essentially an antiquated, manual process.

Further, the current system allows for the distributors' resources to be wasted, as there is a sizable pool of scrip in float for a lengthy time period. Since the distributors pay for the scrip up front, the scrip is in float until the time that it is purchased by an organization. Even when a distributor has a check in hand from an organization, it may take days before the check amount is credited to the distributor's account. Thus, the distributors lose cash flow due to their inventory of scrip.

Moreover, because it is a paper money substitute, scrip has all of the disadvantages of paper money. Scrip is subject to counterfeiting, because the paper certificates do not have all of the security features of regular U.S. currency, such as special paper. Also, it may be easily mutilated or destroyed, such as by leaving it in a garment pocket that goes through a washing machine. Additionally, consumers may find it difficult to keep track of their scrip, as it comes in many different shapes and sizes. Some scrip distributors even issue special wallets just to keep track of scrip certificates.

Additionally, a consumer may be able to use scrip only at the specific business that issued the scrip. This is especially true because of the varying discount rates granted by the different businesses. These discount rates may vary from region to region, or even from store to store. Thus, it is inconvenient for consumers to make sure that they have the proper scrip with them, depending on where they are going. There are several examples of prior art systems to address these problems.

U.S. Pat. No. 6,598,788 discloses a method, apparatus, and article of manufacture for dispensing pre-coded scrip. The method comprises the steps of accepting a cashout command at a gaming device, scanning a code on the pre-coded scrip in response to the cashout command, transmitting the code to a remote processor having access to a database for storing and retrieving codes from a plurality of gaming devices, receiving a scrip dispense message from the remote processor, and dispensing the pre-coded scrip. The article of manufacture comprises a data storage device tangibly embodying instructions to perform the method steps described above. One embodiment of the apparatus comprises a scanner for scanning a code on a pre-coded scrip, a scrip dispensing unit for emitting or issuing the scrip to the user, and a processor. The processor is communicatively coupled to the gaming device, the scanner, the scrip dispensing unit, and a remote processor which has access to a database for storing and retrieving codes from a plurality of gaming devices. The processor comprises instructions for transmitting a first message comprising the scanned code to the remote processor and for receiving a second message comprising a scrip dispense message from the remote processor.

U.S. Pat. No. 6,978,250 discloses a system and method for performing and settling an electronic scrip transaction between a merchant and a member and includes a database for storing accounts for one or more participating merchants, scrip distributors, sponsoring organizations, and members. The system also includes merchant terminals, scrip distributor terminals, sponsoring organization terminals, and a system manager terminal, which are interconnected to one another, as well as to the database, over a network, and a member scrip card, such as a magnetic stripe card or a smart card. Transaction information, including the transaction amount, is entered at a merchant terminal and sent over the network to a scrip distributor terminal or system manager terminal, and the member's account is automatically debited by the transaction amount. Additionally, merchant loyalty point credit or tuition credit can be awarded and stored for the member in connection with the transaction amount. The merchant's account is automatically credited with a merchant portion of the transaction amount, and the accounts of one or both of the scrip distributor and the sponsoring organization are credited with respective portions of the balance according to percentages on a look-up table also stored in the database.

U.S. Pat. No. 7,036,727 discloses a method, apparatus, and article of manufacture for autonomously validating issued scrip media. In response to a cashout command, a cashout value is magnetically and visibly recorded on a re-recordable continuous magnetic media portion and a surface suitable for the application of print media, respectively.

U.S. Pat. No. 7,520,810 discloses a method, apparatus, and article of manufacture for transferring credits from one gaming device to another via the use of coded scrip. The method comprises the steps of accepting a cash-out command in the gaming device, scanning a magnetically manifested code uniquely identifying a scrip stored in the gaming device, transmitting a cash-out message comprising the code to a remote processor having access to a database configured to store and retrieve codes from a plurality of gaming devices, receiving a scrip dispense message from the remote processor, and dispensing the scrip. The apparatus comprises a scrip storage unit, a scrip dispensing unit having a scrip transducer for reading and recording a magnetically manifested code on a scrip retrieved from the scrip storage unit, and a processor, communicatively coupled to the scrip transducer and a remote computer having access to a database for storing and retrieving code information from the plurality of gaming devices.

U.S. Pat. No. 8,261,901 discloses an acceptor-dispenser validator system for accepting bills, vouchers, scrip and/or currency into, and for distributing currency or a currency equivalent from, an electronic gaming machine or alternative type of customer service device. The system includes a note acceptor-dispenser assembly to be mounted in or on the machine, the note acceptor-dispenser having a note validator to sense the authenticity, denomination, amount and type of the note passing there through and issue a signal corresponding to the note type to the acceptor-dispenser's processor and the host machine's processor for accumulation of credits. A note box is provided to receive deposited notes as is a note hopper to receive and dispense notes intended for payouts.

U.S. Pat. No. 8,290,879 discloses a system and method for enabling a fundraising program using fundraising cards redeemable by not-for-profit organization (“NPO”) supporters for branded stored-value cards. The system includes a scrip company host system having a server, where the server includes a microcontroller. A remote user device, having a display, is operatively coupled to the scrip company host system and configured to enable access to the scrip company web site. The microcontroller is adapted to detect access to the scrip company web site by a NPO, and cause the plurality of fundraising cards to be distributed to the NPO in response to detecting an order for the plurality of fundraising cards by the NPO. The fundraising cards are distributed to the NPO prior to receiving payment from the NPO for the fundraising cards, thereby making it unnecessary for the NPO to carry a paid-for inventory of fundraising cards.

However, none of the known prior art presents a fully passive system in which both purchasers and sellers have control over donations.

### SUMMARY

The present invention comprises a general purpose standard or reloadable Debit Card in which a percentage of the financial transaction completed with the card is donated to the consumer's chosen charity/non-profit organization. This occurs passively in line with card program parameters and the program processor for collective benefit, creating a convenient charitable spending mechanism and fundraising tool.

Using the system and method of the present invention, partner retailers can donate a % of purchase (2%, 10%, etc.) by a cardholder to their -chosen organizations. At the end of the month, based on data received from the card issuer, program managers such as, www.praxell.com, through payments processors, such as FIS Global, ServeNation will ACH withdraw that % amount from the retailer, and make a donation to the school/organization on behalf of the retailer who, in turn, can receive the tax benefit of the donation. By using the system and method of the present invention, all of this can be accomplished without the problems associated with the prior art.

### BRIEF DESCRIPTION OF THE DRAWINGS

The present invention will be understood more fully from the detailed description given hereinafter and from the accompanying drawings of the preferred embodiment of the present invention, which, however, should not be taken to limit the invention, but are for explanation and understanding only.

In the drawings:

FIG. 1 shows a block diagram of an exemplary computer system for use with the many embodiments of the present invention.

FIG. 2 shows an exemplary computer device for use with the many embodiments of the present invention.

FIG. 3 shows an exemplary mobile device for use with the many embodiments of the present invention.

FIG. 4 is a schematic diagram of the components embodiment of the present invention;

FIG. 5 is a table which shows examples of the types of information stored in the system manager database for an embodiment of the present invention;

FIG. 6 shows a flow diagram of an embodiment of a method according to the present invention.

FIG. 7 shows a flow diagram of an alternative embodiment of a method according to the present invention.

### DETAILED DESCRIPTION OF THE EMBODIMENTS

The present invention will be discussed hereinafter in detail in terms of the preferred embodiment according to the present invention with reference to the accompanying drawings. In the following description, numerous specific details are set forth in order to provide a thorough understanding of the present invention. It will be obvious, however, to those skilled in the art that the present invention may be practiced without these specific details. In other instance, well- known structures are not shown in detail in order to avoid unnecessary obscuring of the present invention.

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations.

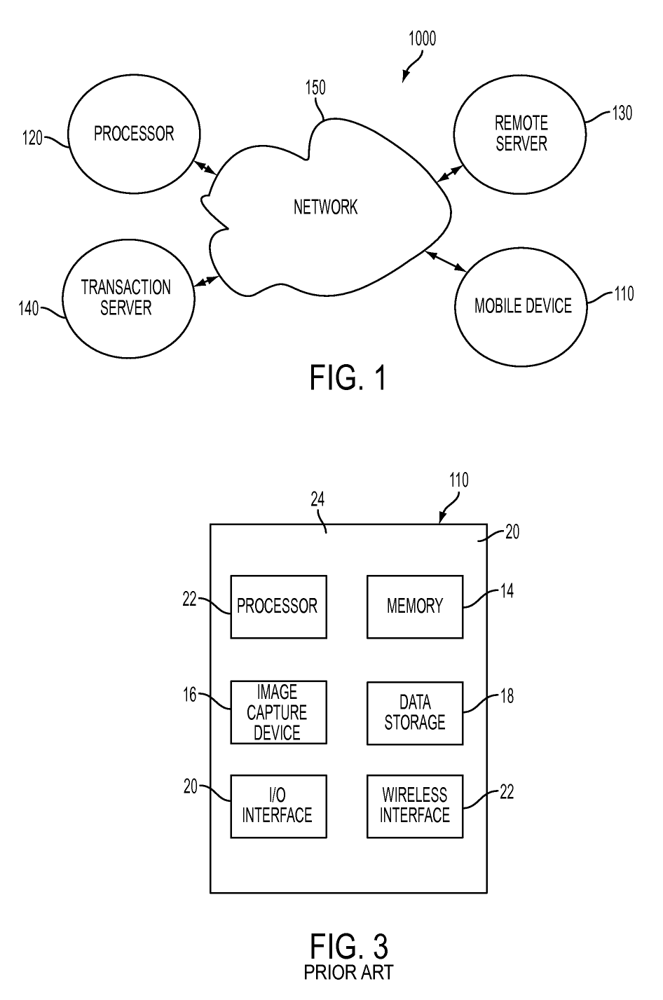

All of the implementations described below are exemplary implementations provided to enable persons skilled in the art to make or use the embodiments of the disclosure and are not intended to limit the scope of the disclosure, which is defined by the claims. In the present description, the terms “upper”, “lower”, “left”, “rear”, “right”, “front”, “vertical”, “horizontal”, and derivatives thereof shall relate to the invention as oriented in FIG. 1.

Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Moreover, the terms “computer program medium” and “computer usable medium” are used to generally refer to physical storage media such as, RAM, ROM, a hard drive, or other memory storage device. These and other various forms of computer program media or computer usable media may store one or more sequences of one or more instructions to a processing device for execution. Such instructions embodied on the medium, are generally referred to as “computer program code” or a “computer program product” (which may be grouped in the form of computer programs or other groupings). When executed, such instructions may enable the computing module to perform features or functions of the present invention as discussed herein.

Turning first to FIG. 1, there is shown a functional block diagram of an exemplary computer system for use with the present invention. As shown in FIG. 1, system 1000 generally comprises: at least one mobile device 110, at least one computer processor 120, a remote server 130, and a transaction (or payment) server 140, and a communication network 150, such as the Internet.

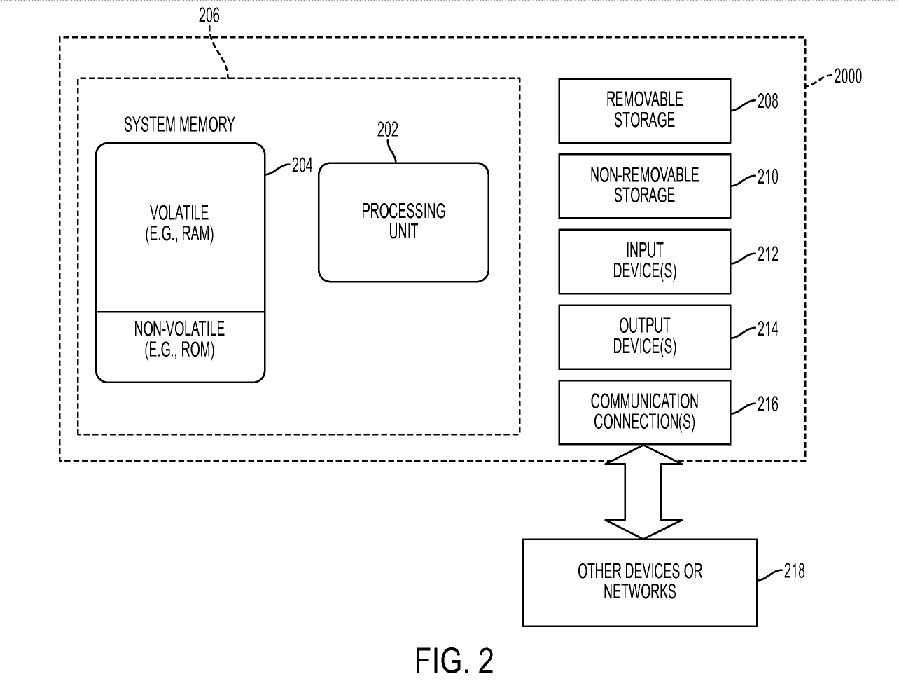

Referring next to FIG. 2, there is shown a functional block diagram generally illustrating a computing device 2000, one or more of which may be adapted for use in the illustrative system for implementing the invention. The computing device may be, for example, a personal computer, a handheld device such as a cell phone, tablet or a personal digital assistant, multi-processor systems, microprocessor-based or programmable consumer electronics, network PCs, minicomputers, mainframe computers and the like. The invention may also be practiced in distributed computing environments where tasks are performed by remote processing devices that are linked through a communications network. In a distributed computing environment, program modules may be located in both local and remote memory storage devices.

In its most basic configuration, computing device 2000 typically includes at least one processing unit 202 and system memory 204. Depending on the exact configuration and type of computing device, system memory 204 may be volatile (such as RAM), non-volatile (such as ROM, flash memory, etc.) or some combination of the two. The basic configuration of the device 2000 is illustrated in FIG. 2 within dashed line 206.

Device 2000 may also have additional features and functionality. For example, device 2000 may also include additional storage (removable and/or non-removable) including, but not limited to, magnetic or optical disks or tape. Such additional storage is illustrated in FIG. 1 by removable storage 208 and non-removable storage 210. Computer storage media includes volatile and nonvolatile, removable and non-removable media implemented in any method or technology for storage of information such as computer readable instructions, data structures, program modules, or other data. System memory 204, removable storage 208, and non-removable storage 210 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by device 2000. Any such computer storage media may be part of device 2000.

Device 2000 includes one or more input devices 212 such as a keyboard, mouse, pen, puck, voice input device, touch input device, scanner, or the like. One or more output devices 214 may also be included, such as a video display, audio speakers, a printer, or the like. Input and output devices are well known in the art and need not be discussed at length here.

Device 2000 also contains communications connection 216 that allows the device 2000 to communicate with other devices 218, such as over a local or wide area network. Communications connection 216 is one example of communication media. Communication media includes any information delivery media that serves as a vehicle through which computer readable instructions, data structures, program modules, or other data may be delivered on a modulated data signal, such as a carrier wave or other transport mechanism. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, electromagnetic (e.g., radio frequency), infrared, and other wireless media. The term computer readable media as used herein includes both storage media and communication media.

Turning now to FIG. 3, there is shown an illustrative block diagram of an exemplary prior art mobile device, such as a smart phone, tablet computer, notebook computer, laptop computer, or the like for use with one or more aspects of the present invention. As shown in FIG. 3, mobile device 110 generally comprises a processor 12, a memory storage device 14, an image capture device 16, a data storage device 18, a plurality of input/output interfaces 20, and a wireless communication interface 22, where all of these components are in electronic communication with one another and contained within a physical housing 24.

Mobile device 110 includes a mobile processor 12. Mobile processor 12 can be a microprocessor or the like that is configurable to execute program instructions stored in mobile memory 14 and/or the mobile data storage 18. Mobile memory 14 is a computer-readable memory that stores data and/or computer program instructions for execution by processor 12.

Page 13 of 21 Mobile memory 14 can include volatile memory, such as RAM and/or persistent memory, such as flash memory. Mobile data storage 18 is a computer readable storage medium that can be used to store data and or computer program instructions. Mobile data storage 18 includes a hard drive, flash memory, a SD card, and other types of data storage.

Mobile device 110 also includes image capture device 16, such as a digital camera. Image capture device 16 can include various features, such as auto-focus, optical zoom or digital zoom. Image capture device 16 captures image data and stores the data in mobile memory 14 and/or mobile data storage 18 of mobile device 110.

Mobile device 110 uses a wireless interface 22 to send and/or receive data across a wireless network. The wireless network can be a wireless LAN, a mobile phone carrier's network, Bluetooth, or other types of wireless network.

I/O interface 20 allows mobile device 110 to exchange data with peripherals such as a personal computer system. A USB interface allows the connection of mobile device 110 to a USB port of a personal computer system to transfer data such as contact information to and from the mobile device and/or to transfer image data captured by image capture device 16 to the personal computer system.

As used herein, the term “module” may describe a given unit of functionality that can be performed. As used herein, a module may use any form of hardware, software, or a combination thereof. A module can include one or more processors, controllers, ASICs, PLAs, logical components, software routines or other mechanisms. Any module described herein may be used as discrete modules or the functions and features described can be shared in part or in total among one or more modules.

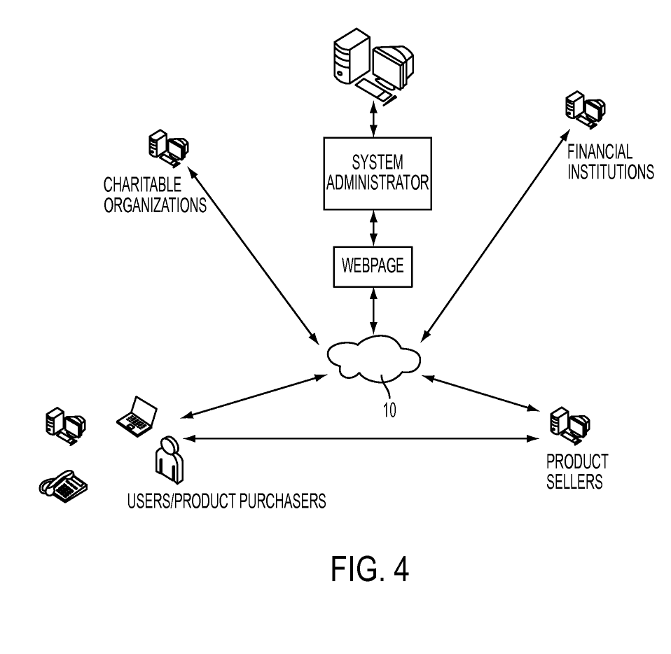

Turning now to FIG. 4, there is shown a functional block diagram of the components of the present inventive system 1000. As illustrated in FIG. 4, the system generally comprises: a computer communication network 10, such as the Internet; at least one product purchasers 20 having a credit or debit card 21 issued by a bank and having an account number at least one charitable organization 30 connected to system 1000 through network 10; a system administrator 40 connected to system 1000 through network 10; one or more financial institutions 50 connected to system 1000 and the other components therein through network 10; and one or more product or service sellers 60 connected to system 1000 and the other components therein through network 10.

As illustrated in FIG. 4, system 1000 comprises distinct components. However, those of skill in the art will appreciate that the functions described herein below may, in all cases, be performed by one or several computing devices having communication means. Such computing devices may be laptop computers, desktop computers, tablet computers, or smart phones, or other computing devices.

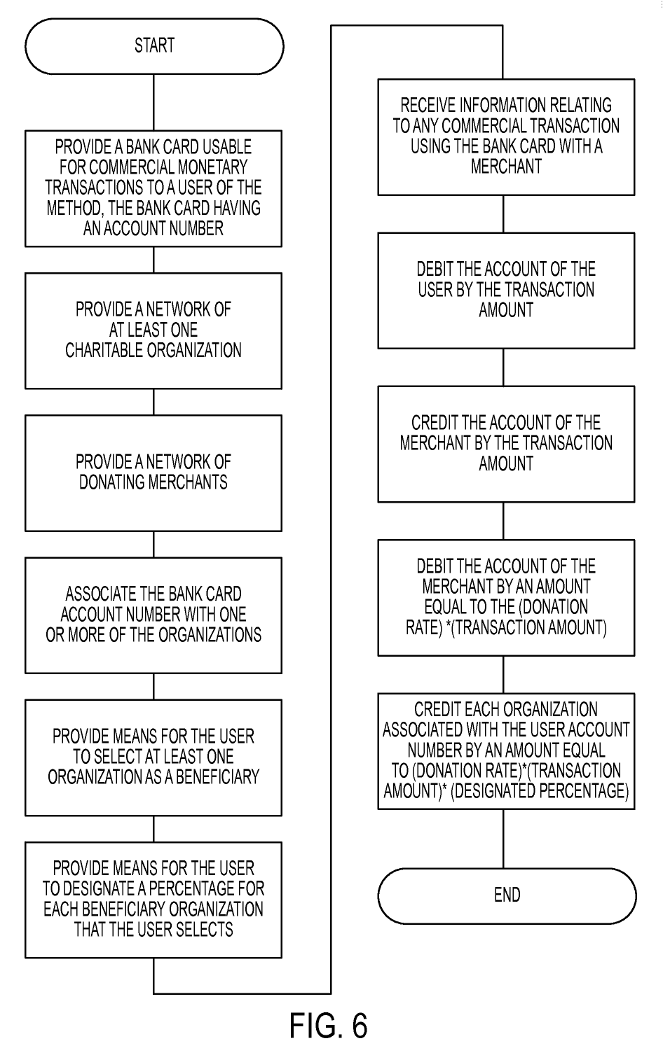

Referring again generally to FIG. 4 and more specifically to FIG. 6, the present invention functions as follows to facilitating a monetary donation to a charitable organization. First, a buyer 20 acquires a bank card 21 from an appropriate bank. Card 21 has an account number, and it is usable for commercial monetary transactions via financial institutions through traditional means for in person, online, or phone initiated credit card transactions. Product providers within system 1000 have means for receiving credit card account information such as magnetic strip readers, bar code scanners, biometric scanners, human sales people with computer keyboards, voice analyzers, and the like.

The account number of bank card 21 is correlated via system 1000 to at least one charitable organization. In one exemplary embodiment, system 1000 includes a webpage that displays a list of participating charitable beneficiary organizations. Users (aka product buyers) can log on to system 1000 via the webpage using a computer device such as a mobile phone, or computer and choose one or more participating charitable organizations as beneficiaries. In similar fashion, each product seller, via system 1000, may designate a “donation rate” which defines a percent of each transaction to be donated to the organizations within system 1000. Product buyers then designate specific whole number percentages of each available dollar to donate to specific organizations such that the total percentage always equals 100.

System 1000 thus correlates the account number of the purchaser's bank card to the designated beneficiary organization or organizations in the chosen amounts. Similarly, product providers sign up for system 1000 through known means, such as online via a password protected website or by contacting a live representative of system 1000. Financial institutions and/or participating products sellers report each transaction using a user's bank card or account number to system 1000.

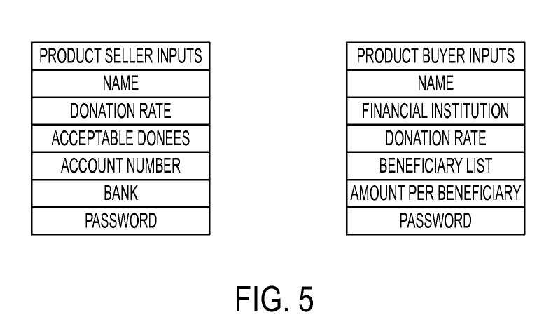

System 1000 may incorporate a plurality of databases (illustrated in FIG. 5) for receiving purchaser and buyer information. Said purchaser and buyer information may, as illustrated in FIG. 5, corporate name, title, company name, contact, address, financial information, username, or password information.

Then, system 1000, upon receiving information relating to any commercial transaction using the purchaser's bank card with a product seller, debits the account of the user by the transaction amount, credits the account of the product seller by the transaction amount, and debits the account of the product seller by an amount equal to the formula:

Donation amount=(donation rate)*(transaction amount). System 1000 then credits each organization associated with the user account number by an amount equal to the formula:

Beneficiary credit=(donation rate)*(transaction amount)*(designated percentage).

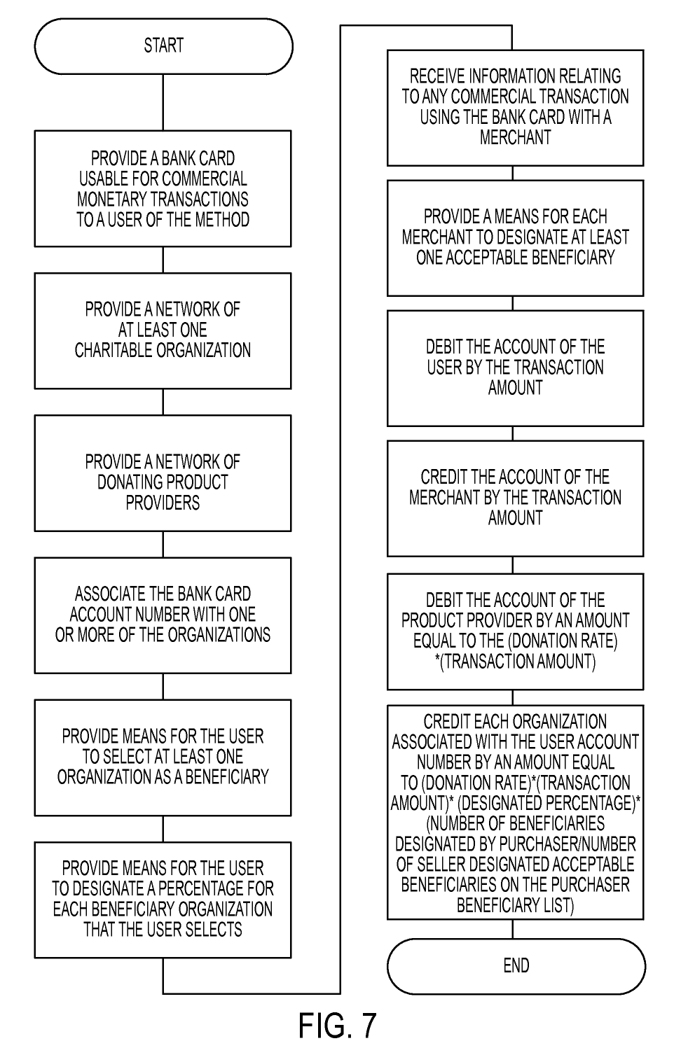

Referring now generally to FIG. 4 and more specifically to FIG. 7, in an alternative embodiment, a product seller may choose the beneficiary organizations with which it will participate. System 1000 then limits donation amounts to based on an analysis of both the product buyer designated beneficiaries and the product seller beneficiaries. For example if a buyer chooses to give 25% to each of 4 organizations, but product seller has limited its participation to only 3 of the four organizations, only 75% of the possible donation amount will be made. The buyer may designate a particular organization to receive any surplus donation amount, or system 1000 may recalculate the donations such that 33.3% goes to each mutually designated beneficiary.

Where sellers do not define all of the user designated beneficiary organizations, the system calculates a donation amount to each user designated beneficiary organization in an amount equal to:

Donation Amount=(donation rate)*(transaction amount)*(designated percentage)*(number of beneficiaries designated by purchaser/number of seller designated acceptable beneficiaries on the purchaser beneficiary list).

The above-described embodiments are merely exemplary illustrations set forth for a clear understanding of the principles of the invention. Many variations, combinations, modifications, or equivalents may be substituted for elements thereof without departing from the scope of the invention. It should be understood, therefore, that the above description is of an exemplary embodiment of the invention and included for illustrative purposes only. The description of the exemplary embodiment is not meant to be limiting of the invention. A person of ordinary skill in the field of the invention or the relevant technical art will understand that variations of the invention are included within the scope of the claims.

1. A computer implemented method of facilitating a monetary donation to a charitable organization, where the monetary donation is based on a percentage of a monetary transaction and the steps of the method are performed by one or more programmed computer processors, the method comprising the steps of: providing a bank card usable for commercial monetary transactions to a user of the method, the bank card having an account number; providing a network of at least one charitable organization; providing a network of donating product providers, where each product provider has a financial account and each product provider defines a donation rate; associating the bank card account number with one or more of the organizations; providing means for the user to select at least one organization as a beneficiary; providing means for the user to designate a percentage for each beneficiary organization that the user selects; receiving information relating to any commercial transaction using the bank card with a product provider; debiting the account of the user by the transaction amount; crediting the account of the merchant by the transaction amount; debiting the account of the product provider by an amount equal to the donation rate)*(transaction amount); and crediting each beneficiary organization associated with the user account number by an amount equal to (donation rate)*(transaction amount)*(designated percentage).

2. A computer implemented method of facilitating a monetary donation to a charitable organization, where the monetary donation is based on a percentage of a monetary transaction and the steps of the method are performed by one or more programmed computer processors, the method comprising the steps of: providing a bank card usable for commercial monetary transactions to a user of the method, the bank card having an account number; providing a network of at least one charitable organization; providing a network of product providers, where each product provider has a financial account and each product provider defines a donation rate; associating the bank card account number with one or more of the organizations; providing a means for the user to select at least one organization as a beneficiary; providing a means for the user to designate a percentage for each beneficiary organization that the user selects; receiving information relating to any commercial transaction using the bank card with a product provider; providing a means for each product provider to designated at least one acceptable beneficiary; debiting the account of the user by the transaction amount; crediting the account of the product provider by the transaction amount; debiting the account of the product provider by an amount equal to the (donation rate)*( transaction amount); and crediting each organization associated with the user account number by an amount equal to (donation rate)*(transaction amount)*(designated percentage)*(number of beneficiaries designated by purchaser/number of seller designated acceptable beneficiaries on the purchaser beneficiary list).

3. A computer implemented system for facilitating a financial donation to a charitable organization, where the monetary donation is based on a percentage of a financial transaction and where the system includes one or more programmed computer processors connected via a computer network, the system comprising: a bank card usable for monetary transactions, the bank card having an account number; a network of at least one charitable organization; a network of donating product providers, where each product provider has a financial account; means for each product provider to define a donation rate; means for associating the bank card account number with one or more of the organizations; means for the user to select at least one organization as a beneficiary; providing means for the user to designate a percentage for each beneficiary organization that the user selects; means for receiving information relating to any commercial transaction using the bank card with a product provider; means for debiting the account of the user by the transaction amount; means for crediting the account of the product provider by the transaction amount:, means for debiting the account of the product provider by an amount equal to the (donation rate)*(transaction amount; and means for crediting each organization associated with the user account number by an amount equal to (donation rate)*(transaction amount)*(designated percentage).
